(19) United States
(12) Patent Application Publication
(10) Pub. No.: US 2016/0061180 A1
(43) Pub. Date: Mar. 3, 2016

(54) WAVE ENERGY CONVERTER

(71) Applicant: POLYGEN LIMITED, Chesterfield, Derbyshire (GB)

(72) Inventor: Robert Eavis, Derbyshire (GB)

(21) Appl. No.: 14/782,085

(22) PCT Filed: Apr. 4, 2014
(86) PCT No.: PCT/GB2014/051063

§ 371 Date: Oct. 2, 2015

(30) Foreign Application Priority Data
Apr. 4, 2013 (GB) 1306081.9

(51) Int. Cl. F03B 13/22

(52) U.S. Cl. CPC F03B 13/22

(57) ABSTRACT

A marine wave energy converter is described, comprising a flexible spine (1) and a plurality of blades (2) rotatably mounted on and supported by the spine. Each blade is operable, by ocean waves travelling parallel to the longitudinal axis of the spine, to angularly oscillate and thereby to drive the conversion of marine wave energy into useful work, such as into electrical energy. The spine (1) is resiliently flexible and comprises one or more elongate structural elements (3) and a plurality of connectors (5, 6) mounted along a continuous length thereof, wherein the/each elongate structural element (3) is a conduit. Each blade (2) is hingedly secured to the spine (1) at a said connector (5), so as to rotate about a hinge axis perpendicular to the longitudinal axis of the spine.

### TECHNICAL FIELD OF THE INVENTION

The present invention relates to a marine wave energy converter.

### BACKGROUND TO THE INVENTION

The substantial energy present in ocean waves is largely unexploited, despite increasing global demand for renewable energy. Traditional wave energy conversion systems are typically either mounted on the sea bed or supported near the ocean surface on a floating platform or by means of floats. Floating systems can capture the maximal energy wave motion occurring nearest to the ocean surface, but must typically be held in place by extremely strong moorings or on vertically sliding supports mounted on the sea bed. Such wave energy conversion systems and their moorings and/or mountings must therefore resist the often extreme loading of ocean waves and withstand the resulting large fluctuating stresses imparted to the structure, including high stress concentrations around mooring connectors and/or fixed mountings. Due to the complexity of repairing offshore systems, wave energy converters are engineered to safely withstand such extreme stress and fatigue regimes and the corrosive nature of the harsh marine environment, for example by the use of custom-designed, massive loadbearing components of stainless steel or other corrosion-resistant metal alloys. The resulting high construction, installation, and operating costs may therefore prohibit the widespread use of wave energy capture devices.

Objects of embodiments of the present invention therefore include: the provision of an improved wave energy converter; a wave energy converter that overcomes the drawbacks outlined above; a wave energy converter that facilitates installation, inspection, maintenance and repair; and/or a low-cost alternative to traditional wave energy converters.

### SUMMARY OF THE INVENTION

According to a first aspect of the invention, there is provided a wave energy converter comprising a flexible spine and a plurality of blades rotatably mounted on and supported by the spine, wherein each blade is operable by ocean waves to angularly oscillate and thereby to drive the conversion of marine wave energy into useful work, such as into electrical energy or into another form of mechanical energy.

The spine may consist substantially of one or more conduits, and may comprise a plurality of substantially parallel conduits.

Each blade may be operable by ocean waves to drive a hydraulic fluid into and along the spine, such as into and along a conduit of the spine. The hydraulic fluid may be seawater. The spine may be fluidly connected to a turbine, which may be located onshore or may be located on a buoyant raft. Alternatively, the wave energy converter may be used to convey the hydraulic fluid to a desired destination other than a turbine, such as to pump seawater to a desalination plant. As a further alternative, each blade may drive a respective electrical generator.

The blades may be spaced about the longitudinal axis of the spine. Two or more said blades may be substantially angularly equispaced about the longitudinal axis of the spine, and may be mounted at substantially the same longitudinal position along the spine.

Two or more said blades may be spaced along the spine. Two of said blades may be separated by a distance of at least half the predominant wavelength at a marine location where the converter is deployed, may be separated by a distance of at least said predominant wavelength, may be separated by a distance of at least half the maximum wavelength at the marine location where the converter is deployed, and may preferably be separated by a distance of at least said maximum wavelength. Two of said blades may be separated by a distance of at least 150 m, may be separated by a distance of at least 300 m, may be separated by a distance of at least 450 m, and may be separated by a distance of at least 600 m.

Two of said blades may be separated by a distance less than or equal to half the predominant wavelength at a marine location where the converter is deployed, and may be separated by a unit fraction of said predominant wavelength. Two of said blades may be separated by a distance of less than 100 m, less than 75 m, less than 60 m, less than 50 m, less than 40 m, less than 30 m, less than 20 m, or less than 10 m, may be separated by a distance of at least 10 m, at least 20 m, at least 30 m, at least 40 m, or at least 50 m, and may be separated by a distance of substantially 50 m. Each of said blades may be separated from another said blade by a distance less than or equal to half said predominant wavelength. Each of said blades may be separated from another said blade by a distance of less than 100 m, less than 75 m, less than 60 m, less than 50 m, less than 40 m, less than 30 m, less than 20 m, or less than 10 m, may be separated from another said blade by a distance of at least 10 m, at least 20 m, at least 30 m, at least 40 m, or at least 50 m, and may be separated from another said blade by a distance of substantially 50 m.

The spine may be substantially linear. The wave energy converter may be deployed at a marine location with the spine substantially in alignment with a predominant wave velocity at the marine location.

The marine buoyancy of at least one of the spine and the blades may be effective to support the blades at a desired depth, and may be effective to support the spine in substantial conformity with ocean surface waveforms.

The wave energy converter may be arranged to accommodate flexion of the spine in substantial conformity with ocean surface waveforms, and may be arranged to provide flexion of the spine in substantial conformity with ocean surface waveforms.

The spine may be resiliently flexible, may be substantially formed of a polymer or polymer-based composite, and may be substantially formed of polyethylene. The blades may be substantially formed of a polymer or polymer-based composite, and may be substantially formed of polyethylene.

The relative buoyancy of the spine and blades may be effective to support the blades in a desired orientation, and may be effective to support the blades in a substantially upright orientation. The blades may be positively buoyant relative to the spine, and may contain air. The spine may be weighted.

The wave energy converter may comprise adjustable buoyancy means, and may comprise self-regulating buoyancy means. The buoyancy means may inflatable floats, may comprise compressible air bladders, and may comprise an air pump.

The wave energy converter may predominantly comprise polymer and/or polymer-based composite parts, and may predominantly comprise polyethylene parts. The wave energy converter may comprise polymer bearing surfaces, and may comprise polyethylene bearing surfaces.

Each blade may be supported on the spine at a hinge. Each blade may drive a hydraulic cylinder, which may be supported on the spine at a hinge, may be fluidly connected to the spine at a non-return valve, and may be fluidly connected to the spine via a point of weakness. Each hinge may be a knuckle hinge, may comprise a releasable pin, may comprise polymer-on-polymer bearings, and may comprise at least one polyethylene bearing surface.

The spine may comprise two or more elongate structural elements substantially aligned in parallel. The elongate structural elements may be rotatably secured to one another to permit relative axial rotation of each said element, may be slidably secured to one another to permit relative axial sliding of each said element, and may secured to one another at polymer-on-polymer bearings. Each of said elongate elements may be a conduit, may be substantially formed of a polymer or a polymer-based composite, and may be substantially formed of polyethylene.

According to a second aspect of the invention, there is provided a method of installing, maintaining, inspecting, or repairing a wave energy converter including the steps of providing a wave energy converter as defined above and towing it from a first marine location to a second marine location. The one of the first and second locations may be an offshore operating location, and the other location may be a shore location.

According to a third aspect of the invention, there is provided a method of installing, maintaining, inspecting, or repairing a wave energy converter including the steps of providing a wave energy converter as defined above at a marine location and adjusting its buoyancy to raise or lower it from a first depth to a second depth. One of the first and second depths may be an operating depth at which the converter is substantially immersed, and the other of the first and second depths may be a depth at which the converter is not substantially immersed.

According to a fourth aspect of the invention, there is provided a method of operating a wave energy converter including the steps of: providing a wave energy converter as defined above, operating the wave energy converter at a marine location at a first operating depth, and adjusting its buoyancy to lower it to a second depth. The second depth may be an operating depth selected to achieve a desired wave power input, electrical power output, blade loading, spine loading, or hydraulic fluid pressure in the converter. The second depth may be a safe depth selected to minimise wave power input or blade loading. The buoyancy adjustment may be made autonomously by a mechanically self-regulating arrangement, may be made autonomously by a monitoring and control system, may be made continuously, and may be made by human intervention.

### DETAILED DESCRIPTION OF THE INVENTION

In order that the invention may be more clearly understood, embodiments thereof will now be described, by way of example only, with reference to the accompanying drawings, of which:

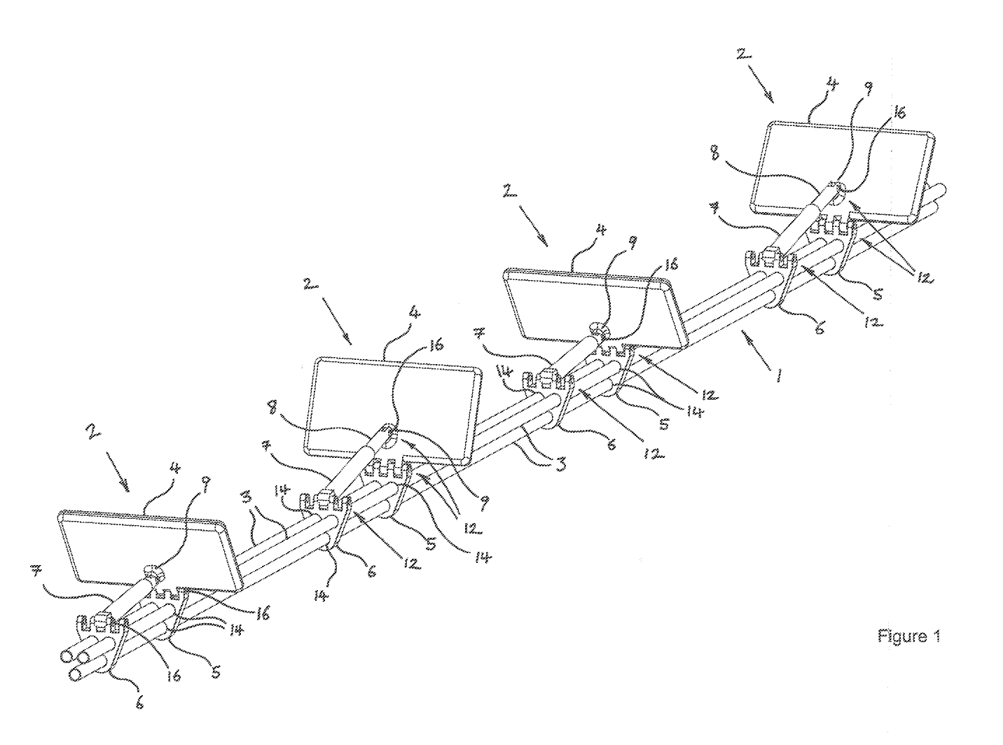

FIG. 1 is a perspective view of part of a wave energy converter according to an embodiment of the present invention;

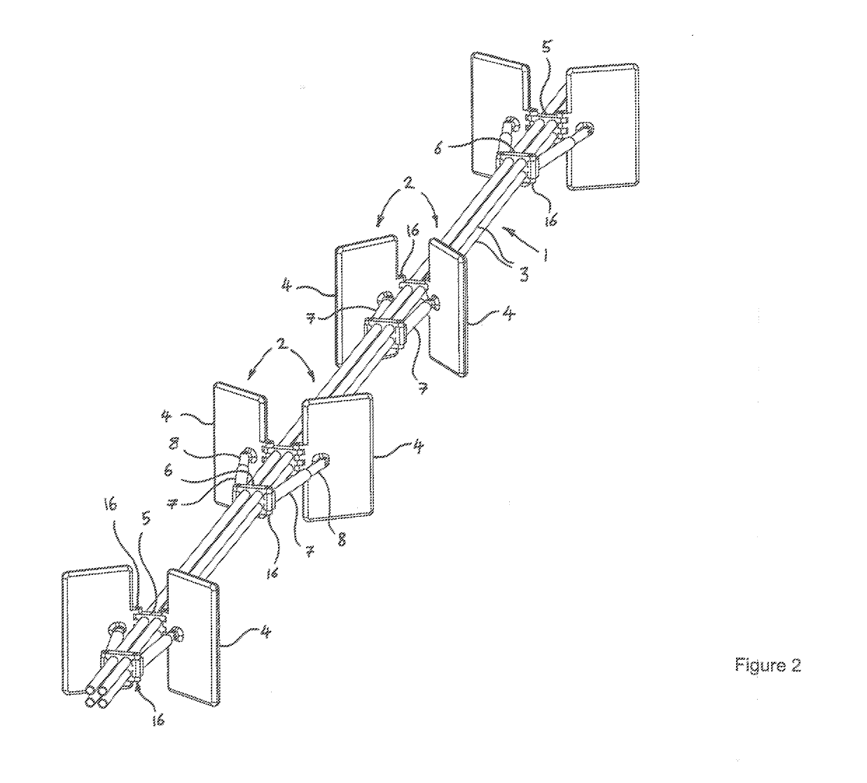

FIG. 2 is a perspective view of part of a wave energy converter according to another embodiment of the present invention;

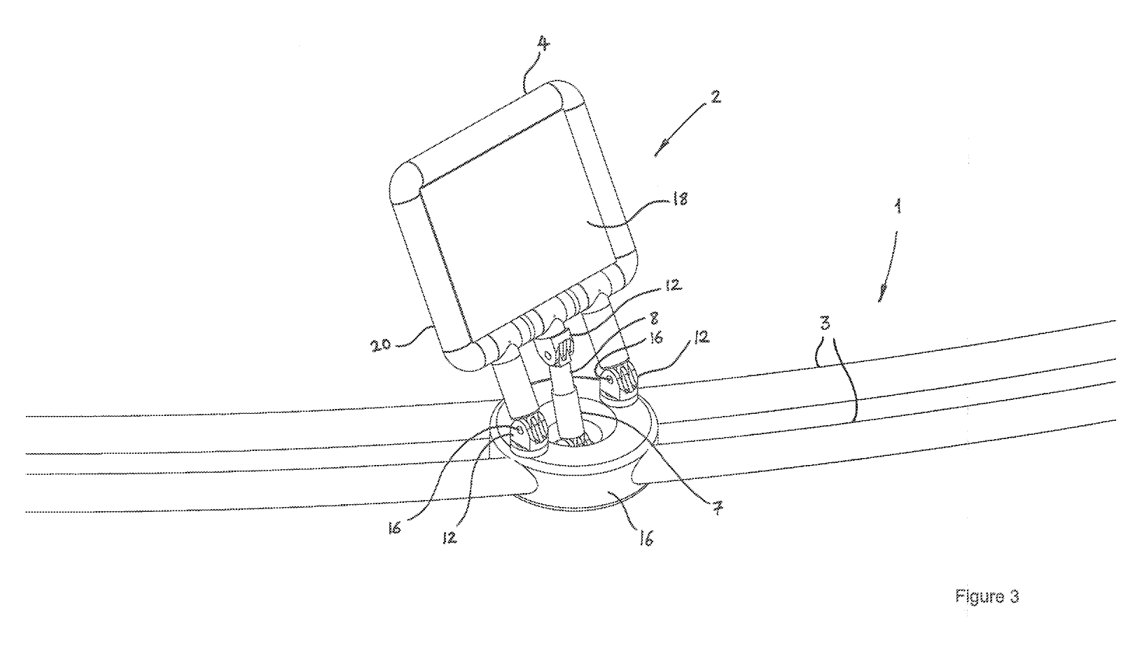

FIG. 3 is a perspective view of part of a wave energy converter according to a further embodiment of the invention;

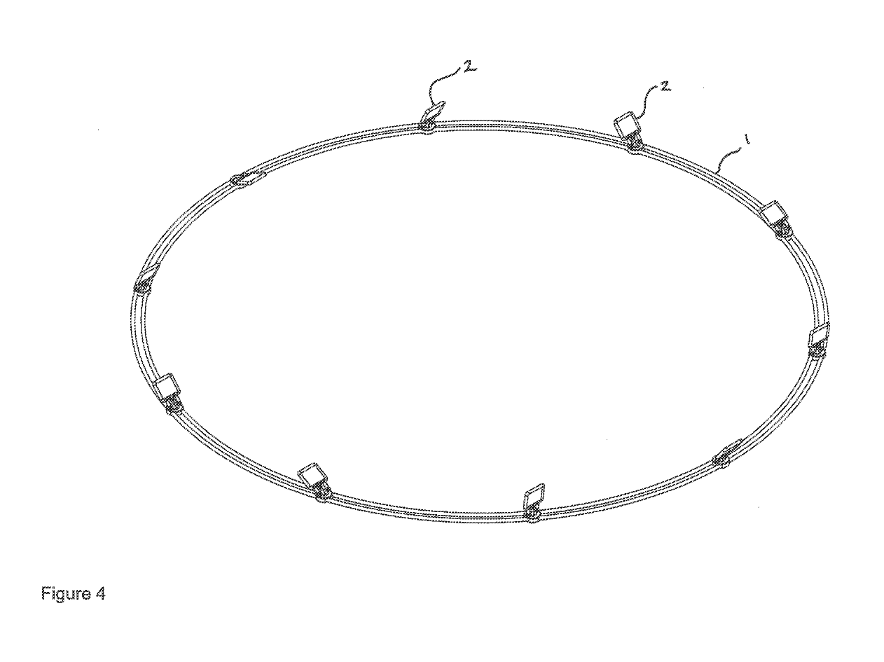

FIG. 4 is a perspective view of a wave energy converter according to an embodiment of the invention and comprising the part shown in FIG. 3;

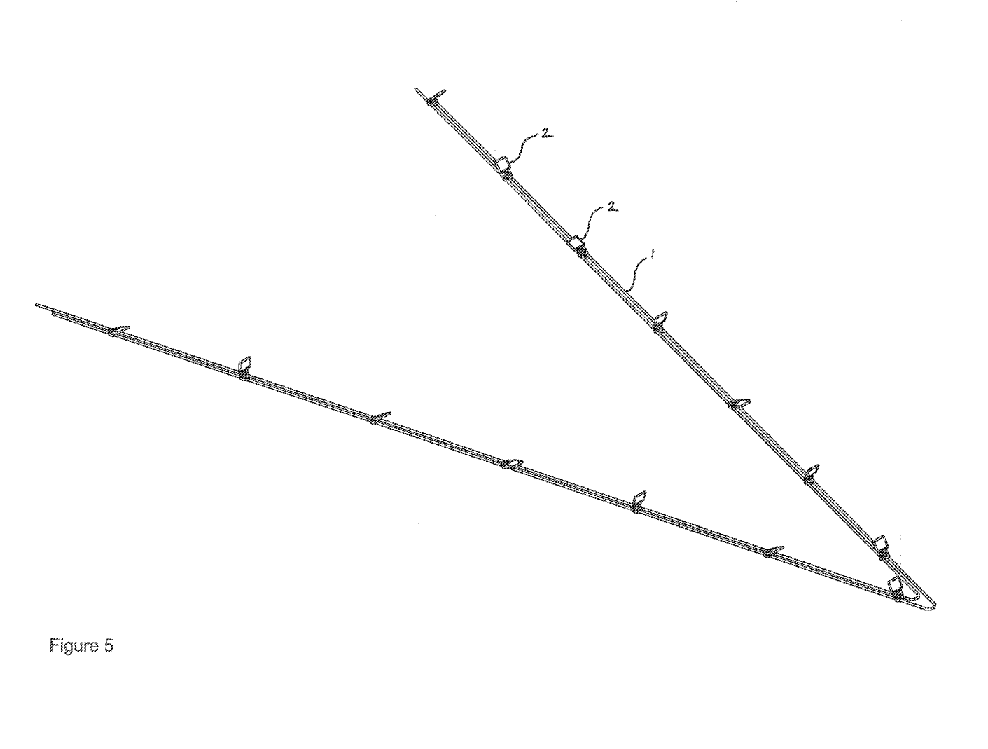

FIG. 5 is a perspective view of a wave energy converter according to a further embodiment of the invention and also comprising the part shown in FIG. 3.

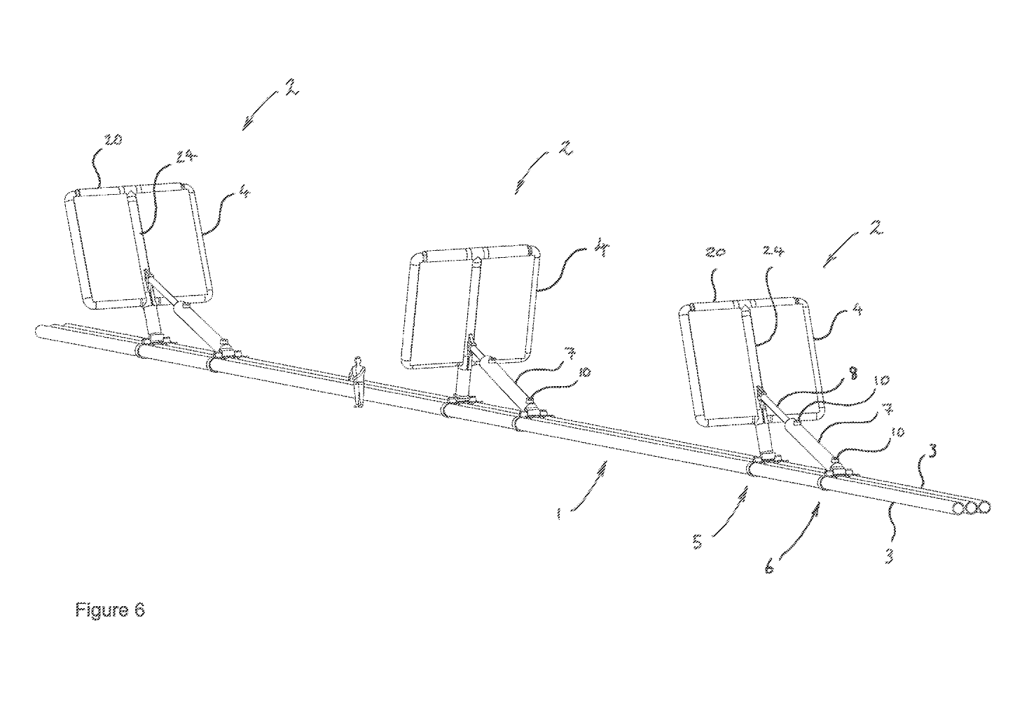

FIG. 6 is a perspective view of part of a wave energy converter forming yet another embodiment of the present invention; and

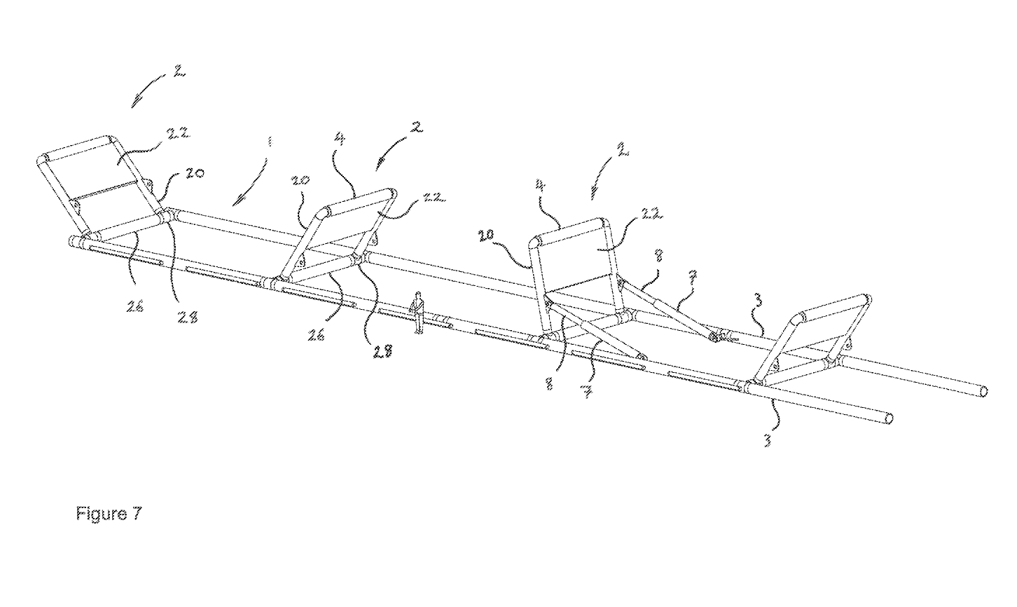

FIG. 7 is a perspective view of part of a wave energy converter according to a further embodiment of the invention.

The present invention concerns a marine wave energy conversion system, embodiments of which are shown in FIGS. 1 to 7. The system shown in FIG. 1 is based on a central supporting spine (1) and a number of movable blades (2) secured to the spine. The spine is formed from three substantially parallel tubular pipes (3) secured to one another at regular intervals to form a sturdy beam on which the blades are supported. Each blade takes the form of a hollow paddle (4) rotatably secured to the spine at a hinged connector (5). The paddle takes the form of a substantially cuboidal block, but alternative designs are envisaged for optimal power conversion efficiency and/or to favourably accommodate internal stresses, as well as factors such as environmental requirements, component availability and cost. The paddles may for instance be curved, to collect more of the wave energy for either the fore or return strokes, or both. This may for example require that one or both major surfaces are substantially concave.

A second hinged connector (6) secured to the spine supports a proximal end of a double-acting hydraulic cylinder (7) with a piston (8) slidably engaged in the cylinder and rotatably secured at its distal end to the paddle via a third hinge joint (9). The hydraulic cylinder has fluid connections near each end (10) through which a hydraulic fluid is drawn in the customary manner so that fluid is drawn into one end of the cylinder and forced out of the other as the piston is drawn from one to the other, and vice versa. The cylinder's connections are fluidly connected via an intake and valve arrangement (not shown) to one of the parallel pipes of the spine, so that rotational movement of the paddle about its hinged connector (5) is effective to draw an external fluid into the cylinder via a filter at the intake and to discharge it under pressure into the connected pipe of the spine, regardless of the direction in which the paddle is moved. Thus, when the system is deployed at sea, wave motion drives the paddle to and fro and thereby draws sea water into the cylinder and discharges it under pressure into the connected pipe in the spine.

A number of the paired paddles and hydraulic cylinders are thus secured to the spine at regular intervals to form an elongate array of equispaced blades, each of which is effective to drive pressurised water into the spine in response to wave motion. One end of the connected pipe of the spine is closed and the other feeds into a turbine connected to a generator to convert wave energy into electrical power. The spine is preferably held at a fixed geographical position, such as by moorings, so that it is maintained in axial alignment with the wave velocity direction and the paddles are thus loaded parallel to the spine's axis.

In certain embodiments, two or more of the pipes of the spine are used to convey pressurised fluid to the turbine, to reduce the pressure-induced loading of any one pipe by distributing it more evenly between two or more. To improve energy conversion efficiency by minimising the pressure loss along a pipe, a larger diameter of pipe is generally preferable. However, the use of multiple pipes of a smaller diameter can achieve a similar benefit. A preferred bending strength and flexural stiffness of the spine may be achieved by providing a suitable number of parallel pipes secured together and, further, by laterally spacing them apart from one another by a suitable distance. The pipes may be secured to and spaced from one another by the hinged connector (5) or by any suitable means.

In certain embodiments, instead of sea-water intakes at each hydraulic cylinder, the cylinder's end connectors may be connected using a valve arrangement between two pipes in the spine to provide a flow return from the turbine. The hydraulic system thus forms a closed loop and a hydraulic fluid other than sea water may be used.

In another embodiment, instead of the hydraulic system a respective electrical generator is provided at each blade, for example mounted in or connected to its supporting hinge, for direct conversion of the kinetic wave energy into electrical power.

Where a hydraulic power take-off system is used, the turbine may be located onshore and the spine, or at least some of its pipes, or a further intervening pipe, extends to the shore for connection to the turbine. However, where the wave energy-capturing structure is to be located a long way offshore, it may be more efficient and/or cost-effective to support the turbine on a floating unit near to the wave energy capturing structure, transferring captured electrical energy to shore via subsea cables. To prevent excessive loading and/or wear of the pipes where connected to the floating turbine unit, the spine or connecting pipes are configured to allow relative motion between the unit and the spine, for example by providing multiple coils or kinks in the pipes near the turbine unit that are capable of accommodating and withstanding any relative movement.

Pressure in any such hydraulic system is regulated by a control system to optimise power transmission, and flow to the turbine may be regulated by means of a hydraulic accumulator.

In preferred embodiments, the separation between adjacent blades on the spine is a unit fraction of the mean wavelength, λ/n, where n is an integer greater than or equal to 2 and λ is the wavelength of a frequently experienced and energetically significant principal wave component, such as the most frequently occurring wavelength or the shortest frequently-occurring wavelength at which wave power can be usefully captured. This helps to ensure that the wave-induced forces and moments between n adjacent blades are cancelled out to some extent. The local forces and bending moments within the spine are thus minimised by avoiding additive effects from multiple adjacent blades loaded in phase, and the net forces and moments acting on the spine as a whole are minimised. For example, in a preferred embodiment where n=2, each blade will be loaded approximately 180° out of phase with its neighbour so that the net force acting on the spine is much lower than would be the case for n=1, and the bending moment in the spine should not exceed the wave-induced moment acting on a single blade. By ensuring that axial forces and bending moments are minimised in this manner, the system can be safely designed to withstand significant wave forces using relatively inexpensive materials, such as plastics or polymer-based composites for at least the main structural components of the spine and blades, and standard low-cost mooring systems for holding the spine in place. To achieve this force-cancelling effect, the blades furthest apart (e.g. at either end of a spine) must be separated by a distance of at least λₘₐₓ/n and preferably at least λₘₐₓ, where λₘₐₓ is the maximum wavelength that the structure is designed to withstand, such as the longest wavelength observed at the marine location at which it will be deployed or the longest wavelength observed under marine conditions under which the wave energy converter is expected to remain operational, although it is generally preferred that the blade array is significantly longer than this value.

Constructing parts of the spine and blades substantially of plastics or polymer-based composites can provide many advantages when compared with typical systems formed from engineering alloys such as stainless steel. For example, polyethylene is relatively inexpensive and readily available in the form of standard components, such as semi-flexible pipes of various diameters. Many polymers are inert and exhibit corrosion resistance far surpassing that of many engineering alloys in a marine environment. The toughness and flexibility of many polymers may allow them to withstand accidental collisions from marine vessels by resiliently deforming, thus avoiding damage to both the wave energy system and the vessel. Low-friction polymers such as polyethylene may be used in the bearings of moving parts, lubricated by sea water and without any requirement for sealed bearings with moving parts or environmentally-hazardous grease.

Furthermore, the low weight of most plastics enables the spine and blades to be made buoyant without the need for additional floats or supports. The spine and blades are preferably hollow, but even where certain parts are made of solid polyethylene, they may be naturally buoyant in sea water. The spine and blades can thus be designed to provide a buoyancy distribution that gives the structure a self-righting capability. Unlike stainless steel parts, these buoyant and self-righting capabilities may be substantially preserved even where a hollow part is punctured or cracked and takes in water, if the bulk plastic material has marine buoyancy, as is the case for polyethylene. Conversely, such punctures and cracks are be less likely to occur, since the excellent toughness, fatigue resistance, and chemical resistance of polyethylene and many other plastics prevent the localised damage caused by fatigue or pitting corrosion that might be experienced by many engineering alloys in a marine environment. Polyethylene parts may be inexpensively fabricated from recycled material and may be recycled after use, further improving the environmental appeal of the system within the renewable energy sector.

As water depth increases, the kinetic and potential energy of the waves dramatically reduces. Therefore it is advantageous for the blades to remain near the water surface, such in contact or near-contact with the surface and generally at a depth less than half the mean wavelength of the waves. The flexibility of the spine permits the blades to track the surface dynamically, maintaining each blade at an optimal depth, even where significant wave heights are present so that the desired vertical position of each blade varies significantly along the length of the spine.

For the arrangement of FIG. 1, the distribution of buoyancy within the structure is such that the blades remain predominantly upright without the need for any torsional constraint to the spine. Transverse loading of the blades will therefore twist the spine rather than overloading the blades and connectors.

For example, the blades may be positively buoyant and the spine slightly negatively buoyant. Since polyethylene is a positively buoyant material, a more dense material may be required to provide the negative buoyancy to keep the structure below the water's surface, even where components do not contain trapped air. The hydraulic cylinders (7) may be wholly or partially formed from polyethylene or another polymer or a polymer-based composite. In the arrangement of FIG. 1 they are instead formed substantially from stainless steel, and it is thus envisaged that sufficiently large, heavy hydraulic cylinders suitably spaced along the spine should provide the weight distribution necessary to keep the blades in a desired position and orientation, i.e. upright and below or substantially below the water's surface. Alternatively, or in addition, distributed weights may be secured along the length of the spine to achieve this effect.

Active buoyancy adjustment of the wave energy converter is further provided, for example by pumping pressurised air into one or more of the spine pipes or into internal or external floatation bags mounted along the spine so that the buoyancy of the spine structure changes. An air pump for this purpose may be mounted onshore, on the spine, or on the nearby floating turbine unit if present.

Buoyancy adjustment in this manner may provide many benefits. The buoyancy can be adjusted so that the depth of each blade provides optimal power transmission for wave energy capture. The optimal depth may depend on current wave conditions and would therefore be adjusted accordingly as they change. The buoyancy of the spine could be increased significantly so that the entire structure surfaces, facilitating inspection and maintenance work. In stormy seas, where excessive wave forces may pose a risk of damage to the structure, the buoyancy adjustment system could be partially or entirely deflated or flooded, to sink the structure to a safe operating depth below the water surface where the wave energy is greatly reduced. This survivability feature preserves the operation and maintainability of the system, as well as further reducing the required strength and cost of its components. Flotation buoys may be provided to prevent the structure from sinking too far.

This buoyancy adjustment may be achieved using a pressure control system having air compression bladders and powered by the hydraulic operation of the blades. It may also be autonomous, such that the pressure inside the spine pipes, which is partially controlled by the control system at the turbine and/or indicative of current wave power, influences the buoyancy of the system. For example, the compression bladders may be mounted in the spine pipes or a tank in fluid connection with the pipes. Reducing the hydraulic pressure expands the bladders and increases the buoyancy of the structure. Increasing the pressure, for example in excess of a safe working limit, deflates the bags and reduces the buoyancy, sinking the structure to a safer operating depth.

Many traditional wave energy converters are difficult to install and repair due to their remote offshore location. The buoyant structure of the present invention, further enhanced any buoyancy adjustment capability, allows it to be conveniently transported by towing. Thus, the device can be wholly or partially assembled onshore or near the shore and then floated to its intended offshore location for connection to moorings, and can similarly be disconnected from its moorings and floated to safety for repair.

Since the structure is designed to be self-supporting under its own buoyancy, it does not need to be vertically supported. Furthermore, since the blade spacing is selected to provide a force-cancelling effect in the spine, the resultant axial force to the spine is minimal. The flexible and rotatable spine ensures that transverse loading of the blades is dissipated as twisting or rotation of the spine rather than lateral movement. As a result, moorings and/or any other form of anchoring or support are required chiefly to prevent the structure from drifting and to maintain the correct alignment of the spine with the direction of wave travel, in contrast to the physical demands placed on moorings and mountings of traditional wave energy systems. The strength requirements for moorings and/or any other anchoring or support means for the present invention are therefore relatively low, and standard inexpensive components may be used for this purpose.

The arrangement of FIG. 1 is fabricated chiefly from polyethylene. To minimise local stresses under marine loading, the spine (1) is formed from three or more medium- or high-density polyethylene pipes (3). These are secured to and spaced from one another at the hinged connectors (5, 6) which are chunky, resilient polyethylene blocks built to withstand heavy loading and to compliantly transmit forces between the pipes and paddles in a distributed manner that avoids high local stress concentrations. The hinged connector blocks may be secured to the pipes by means of an interference fit, for example incorporating a block clamp or circumferential hose-clamp arrangement. However, in preferred embodiments, the connector block fits closely but not tightly around the pipe, and is secured in place by axial abutment over or between plastic stops (not shown) that are secured to the pipe by such a clamp arrangement or by any other suitable means. This freer connection using axial stops on the pipe prevents or reduces the transmission of axial torque to each pipe, whilst securely fastening the pipes and hinged connector in other degrees of freedom, and may also prevent excessive frictional wear to the pipe. It also allows a greater degree of flexion and twisting by the spine than a more rigidly fastened connector, for any given pipe stiffness and strength, thereby better to absorb transverse loading by ocean waves and buoyantly to conform to ocean surface contours to achieve a consistent spine or blade depth. In general, any suitable alternative fastening means may be used, but connectors and other structural elements should preferably be: releasably secured to the pipe, to facilitate removal and replacement of parts without disruption to the pipe; loosely, rotatably, and/or compliantly secured to the pipe, to minimise flexural constraint, stress concentrations, and unnecessary loading of the spine; non-damaging to the structural integrity of the pipe; and/or mounted on a continuous length of pipe, rather than requiring a connection or join between contiguous sections of the pipe. It is preferred that structural elements such as the hinged connectors (5, 6) are not welded to the pipes and that the spinal pipes need not be disconnected in order to fit, remove, or replace a blade or hinged connector.

Each of the hinges (12) securing the hydraulic cylinder (7), paddle (4), and respective connector blocks (5, 6) to one another, and each of the torsionally-decoupled bearings (14) between the connector blocks and the spinal pipes (3), has a smooth polyethylene-on-polyethylene bearing interface. This is advantageously wear-resistant and film-lubricated by sea water to provide a simple, robust, and hardwearing bearing interface without the need for rolling bearings, grease, or sealed bearing capsules. Water-lubricated polyethylene bearing surfaces are preferably used at all sliding and/or rotating interfaces.

Each hinge (12) contains a polyethylene or polyethylene-coated axle forming the hinge pin (16). Due to the large loads borne by the hinge and the relatively high flexibility and low strength of polyethylene axles compared to common metal hinges, the shear and bending stresses in each axle should be minimised to prevent excessive stress and wear. To achieve this, the maximum span of the axle is minimised, for example by the use of knuckle fittings. As shown in FIG. 1, the hinged connector (5) at the root of each paddle has an interdigitating knuckle hinge arrangement to provide multiple short spans along the same axle in the manner of a piano hinge. The interdigitating knuckle hinge (12) is particularly strong in withstanding torsional loading, so it is especially suitable for supporting the paddle which may experience significant twisting loads. A suitably designed polyethylene axle and hinge can provide significant cost savings when compared to the steel bearings traditionally used in marine structures, both in terms of material and fabrication costs and in terms of the longevity of a water-lubricated, corrosion- and wear-resistant joint compatible with the harsh marine environment. Furthermore, unlike traditional sealed bearings, the axles can be easily released and removed from the hinge to facilitate rapid installation, removal, or replacement of a blade or cylinder.

An advantage of using polymer components when compared with metal alloys is that there are typically no detrimental electrochemical effects such as galvanic corrosion when the polymer is in contact with other materials. Therefore, although polyethylene is preferred for many components, it can typically be used in combination with, or replaced by, other polymers and polymer-based composites as well as placed in contact with metal parts without any adverse chemical reaction. For example, nylon hinge bearings are contemplated; and certain specialised parts, such as hydraulic components and mooring connectors, may be necessarily or preferably made of stainless steel or another metal alloy.

Mechanical failure of an individual blade or hydraulic cylinder should not cause the system to fail or interrupt its operation. The connection between a cylinder and spine pipe is therefore provided with a non-return valve placed closely to the spine. The hose or its connection to the valve is provided with a point of failure so that the valve and spine pipe remain intact in the event of mechanical failure or severe damage to the hose or cylinder, to maintain the fluid pressure in the spine pipe, on the downstream side of the non-return valve. The valve further enables installation, removal, and replacement of a blade and its hydraulic cylinder to be performed without any need to shut off flow through the spine pipe. As an alternative, or in addition, groups of blades may be associated with a respective pipe of the spine, so that if one pipe must be taken out of use for maintenance or repair, only a subset of the blades are redundant while the pipe is shut off. As a further alternative, or in addition, the arrangement of valves and hoses by which each hydraulic cylinder is fluidly connected to the spine can include a means for switching the flow of fluid between two or more pipes of the spine, so that flow can be diverted away from a pipe to which installation, maintenance, or repair work is to be performed and the work can thus be undertaken without disruption to the useful operation of each blade.

In a second arrangement shown in FIG. 2, the setup and functionality is substantially the same as for that shown in FIG. 1, except that blades (2) are symmetrically mounted in pairs along the spine (1). The hinged connector blocks (5, 6) are double-sided to support successive opposed pairs of paddles (4) and hydraulic cylinders (7) to which respective paddles are connected. Thus, twice as many paddles are deployed over a given length of pipe, to provide up to twice the electrical power for a given wave velocity. However, an advantage of the two-bladed system of FIG. 2 is that, when the blades experience a wave travelling parallel to the longitudinal axis of the spine, the spine is symmetrically loaded by the paired blades, so that axial loads to the pipes are doubled and bending moments are cancelled out. This means that, where the spine is kept in alignment with the wave velocity direction, a significantly smaller and/or weaker spine can withstand a given wave-induced operating load, when compared with the single-bladed arrangement of FIG. 1. This bending moment-cancelling effect, in addition to the force-cancelling effect achieved by spacing the blades less than one half-wavelength apart, can therefore allow wave energy to be cost-effectively captured using relatively flexible, low-cost components.

The blades (2) are located on either side of the spine and each is secured to the hinged connector block (5) at a respective vertical hinge axis (14) to rotate through a horizontal path. In an alternative arrangement, the blades are located above and below the spine. In further embodiments, the number of blades supported at a connector may be greater than two. For example, three blades may be mounted at an angular separation of about 120° around the spine to provide a similar cancelling-out of bending moments.

A third arrangement shown in FIG. 3 includes a blade (2) mounted on the spine (1) at a cylindrical connector block (16). This arrangement functions in like manner to the arrangements discussed above, except that the blade is hinged to rotate about an axis that need not be perpendicular to the spine axis. The blade takes the form of a tubular frame (20) formed from polyethylene pipe, having a pair of shafts each secured to the connector at a respective interdigitating knuckle hinge (12) and a closed part supported on the shafts and enclosing a rectangular plate (18) to form a paddle. Wave-induced motion of the paddle drives sea water through a turbine via a pipe (3) of the spine, as described above. The arrangement is intended for use where the spine is not aligned with the wave trajectory. The hinges at the root of the blade are attached to the connector in a desired position so that the hinge axis is perpendicular to the anticipated wave velocity.

FIG. 4 shows a configuration in which the pipes (3) of the spine (1) form a closed loop so that the blades (2) of FIG. 3 are supported in a circular formation. All of the blades are aligned in the same direction to capture movement in a principal direction of wave travel. Sea water or another hydraulic fluid circulates in one or both pipes and may drive one or more small turbines or may be diverted to an onshore or floating turbine unit. The circular formation may provide a strong base having a highly stable and relatively firm structure in comparison with a linear spine arrangement. FIG. 5 shows a further configuration in which the spine (1) forms a V-shape. This arrangement provides a staggered blade array intended to minimise the effect of the wake produced by each blade on the downstream blades, to maximise energy capture by each blade and/or reduce the risk of adverse dynamic loading of the downstream blades.

The two arrangements shown in FIGS. 6 and 7 are functionally similar to the system of FIG. 1. In both arrangements, the blade (2) is fabricated as a tubular frame (20) formed from polymer tubing such as polyethylene pipe, and one or more solid or hollow panels (22) are joined to the frame to form a paddle. In FIG. 6, the paddle is reinforced by a central strut (24) of the tubular frame. In FIG. 7, two hydraulic cylinders (7) are provided per blade (2) and connected to each of the two spaced-apart pipes (3) forming the spine (1). In this arrangement, the tubular frame (20) of each blade (2), and the cross-member (26) and hinges (28) at which the root of the blade is secured to the pipes (3) of the spine (1), are substantially formed from standard, inexpensive polyethylene pipes and pipe fittings.

Features of any of the above arrangements may be combined interchangeably as will be apparent to the skilled reader. The above embodiments are described by way of example only. Many variations are possible without departing from the scope of the invention as defined in the appended claims.

1. A wave energy converter comprising a flexible spine and a plurality of blades rotatably mounted on and supported by the spine, wherein:
each blade is operable, by ocean waves travelling parallel to the longitudinal axis of the spine, to angularly oscillate and thereby to drive the conversion of marine wave energy into useful work;
the spine is resiliently flexible and comprises one or more elongate structural elements and a plurality of connectors mounted along a continuous length thereof, wherein each of the one or more elongate structural element is a conduit; and
each blade is hingedly secured to the spine at a said connector so as to rotate about a hinge axis perpendicular to the londitudinal axis of the spine.

2. A wave energy converter according to claim 1 wherein the spine consists essentially of tow or more said elongate structural elements that are substantially aligned in parallel, and secured to and laterally spaced from one another, by the connectors at intervals along the spine, to form a resiliently flexible beam.

3. A wave energy converter according to claim 1 wherein each blade is operable by ocean waves to drive a hydraulic fluid into and along the spine.

4. A wave energy converter according to claim 3 wherein the hydraulic fluid is seawater.

5. A wave energy converter according to claim 1 wherein each blade is operable by ocean waves to drive the conversion of marine wave energy into electrical energy.

6. A wave energy converter according to claim 1 wherein the spine consists substantially of one or more conduits.

7. A wave energy converter according to claim 1 wherein the spine comprises a plurality of substantially parallel conduits.

8. A wave energy converter according to claim 1 wherein the blades are spaced about the longitudinal axis of the spine.

9. A wave energy converter according to claim 8 wherein two or more said blades are substantially angularly equispaced about the longitudinal axis of the spine.

10. A wave energy converter according to claim 8 wherein two or more said blades are mounted at substantially the same longitudinal position along the spine.

11. A wave energy converter according to claim 1 wherein two or more said blades are spaced along the spine.

12. A wave energy converter according to claim 11 wherein two of said blades are separated by a distance greater than or equal to half the predominant wavelength at a marine location where the converter is deployed.

13. A wave energy converter according to claim 11 wherein two of said blades are separated by a distance less than or equal to half the predominant wavelength at a marine location where the converter is deployed.

14. A wave energy converter according to claim 11 arranged to accommodate flexion of the spine in substantial conformity with ocean surface waveforms.

15. (canceled)

16. A wave energy converter according to claim 11 wherein the marine buoyancy of at least one of the spine and the blades is effective to support the blades at a desired depth.

17. A wave energy converter according to claim 11 wherein the marine buoyancy of the blades is effective to support the spine in substantial conformity with ocean surface waveforms.

18. A wave energy converter according to claim 1 wherein the spine is substantially formed of a polymer or a polymer-based composite.

19. A wave energy converter according to claim 1 wherein the blades are substantially formed of a polymer or a polymer-based composite.

20. A wave energy converter according to claim 1 substantially composed of polymer and/or polymer-based composite component parts.

21. A wave energy converter according to claim 20 substantially composed of polyethylene component parts.

22. A method of installing, maintaining, inspecting, or repairing a wave energy converter including the steps of providing a wave energy converter according to claim 16 and towing it from a first marine location to a second marine location.

23. A method of installing, maintaining, inspecting, or repairing a wave energy converter including the steps of providing a wave energy converter according to claim 16 at a marine location and adjusting its buoyancy to raise or lower it from a first depth to a second depth.

24. A method of operating a wave energy converter including the steps of providing a wave energy converter according to claim 16 at a marine location, operating the wave energy converter at a first operating depth, and adjusting its buoyancy to lower it to a second depth.
